(19) United States
(12) Patent Application Publication
(10) Pub. No.: US 2007/0215290 A1
(43) Pub. Date: Sep. 20, 2007

(54) Apparatus and method for applying sealant tape

(76) Inventor: Don Deering, Red Oak, TX (US)

Correspondence Address: DOCKET CLERK, P.O. DRAWER 800889, DALLAS, TX, 75380, US

(21) Appl. No.: 11/713,078

(22) Filed: Mar. 1, 2007

Related U.S. Application Data
(60) Provisional application No. 60/778,474, filed on Mar. 2, 2006.

(51) Int. Cl. B44C 7/00; B32B 37/00; B32B 37/12

(52) U.S. Cl. 156/577; 156/579

(57) ABSTRACT

An apparatus and method for applying sealant tape to a surface are disclosed. One advantageous embodiment of the apparatus comprises a sealant tape cradle and an application roller affixed to a support shaft. The bottom end of the support shaft has two support flanges that support an axle that supports the application roller. The sealant tape cradle holds a roll of sealant tape without using an axle or any other similar support structure. The sealant tape is threaded through an aperture in the bottom of the cradle and around the application roller. An operator applies pressure to the support shaft and causes the application roller to move along a surface and continually apply the sealant tape to the surface. The apparatus can be operated using only one hand.

### CROSS REFERENCE TO RELATED APPLICATIONS

This application claims priority under 35 U.S.C. § 119(e) to U. S. Provisional Patent Application No. 60/778,474 that was filed on Mar. 2, 2006, which is hereby incorporated by reference.

### TECHNICAL FIELD OF THE INVENTION

The present invention is directed, in general, to tools for applying sealant tape and, more specifically, to an apparatus and method for efficiently applying sealant tape to a surface.

### BACKGROUND OF THE INVENTION

In the construction industry it is common to apply sealant tape to metal surfaces. For example, sealant tape is often applied to the edges of adjacent metal sheets to seal the juncture between the metal sheets. The surface of the side of the sealant tape that is applied to the metal surface is covered with a adhesive sealant material. When the adhesive side of the sealant tape is applied to the juncture between two metal sheets, the adhesive material of the sealant tape seals the juncture so that foreign material (such as dirt and liquid) is not able to pass between the juncture of the metal sheets.

One prior art method of applying sealant tape is carried out by hand. Sealant tape that is applied to metal materials comes in rolls. In order to apply the sealant tape, an operator must unroll a length of sealant tape from the roll of sealant tape and apply the unrolled length of sealant tape by hand. After the unrolled length of tape has been applied to the metal material the operator must continue to unroll and apply additional lengths of tape along a length of the metal material.

The manual method of applying sealant tape is awkward and inefficient. The operator must use one hand to hold the roll of sealant tape (and unroll lengths of tape from the roll) and use his or her other hand to apply pressure to the external surface of the applied tape to cause the tape to firmly adhere to the surface of the metal. The operator must also bend over and reach down in order to press against the sealant tape to apply sufficient pressure to cause the adhesive on the sealant tape to seal against the metal material.

Some types of prior art sealant tape applicators employ a roller apparatus in which the roll of sealant tape is mounted on an axle. As the sealant tape is removed from the roll, the roll revolves around the axle. Methods that use sealant tape applicators that employ a roll of sealant tape mounted on an axle are also awkward and inefficient. The operator must still use one hand to hold the apparatus that holds the roll of sealant tape on an axle (and unroll lengths of tape from the roll) and use his or her other hand to apply pressure to the external surface of the applied tape to cause the tape to firmly adhere to the surface of the metal.

Therefore, it would be desirable to have an apparatus and method that would allow an operator to quickly and efficiently apply sealant tape to a surface. In particular, it would be desirable to have an apparatus and method that would allow an operator to quickly and efficiently apply sealant tape to a metal surface.

### SUMMARY OF THE INVENTION

An apparatus and method for applying sealant tape to a surface is disclosed. The apparatus comprises a sealant tape cradle, an application roller and a support shaft. The sealant tape cradle is attached to one end of the support shaft. The bottom end of the support shaft has two oppositely positioned support flanges that support an axle. The application roller is mounted on the axle that is located between the support flanges.

The sealant tape cradle is capable of holding a roll of sealant tape. The interior of the sealant tape cradle does not have an axle or any other similar supporting structure for supporting the roll of sealant tape. To operate the apparatus the sealant tape is threaded through an aperture in the bottom of the cradle and then threaded around the application roller.

During the sealant tape application process an operator presses on the support shaft and causes the application roller to move along an underlying surface. The pressure applied through the application roller as it moves along the surface continually applies pressure to seal the sealant tape against the underlying surface. The operator is capable of applying the sealant tape to the surface using only one hand.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is perspective view of a prior art roll of sealant tape of the type that is applied to a surface;

FIG. 2 is a side view of a sealant tape cradle of the apparatus of the present invention showing in dotted outline the location of a roll of sealant tape within the cradle;

FIG. 3 is a top view of the sealant tape cradle of the apparatus of the present invention showing in solid outline the top of a roll of sealant tape within the cradle;

FIG. 4 is a bottom view of the sealant tape cradle of the apparatus of the present invention showing in dotted outline the location of roll of sealant tape within the cradle and showing a slot in the bottom of the cradle through which the sealant tape may pass;

FIG. 5 is side view of the sealant tape apparatus of the present invention comprising the sealant tape cradle, an application roller and a support shaft;

FIG. 6 is a front end view of the sealant tape apparatus of the present invention showing the position of the application roller beneath the sealant tape cradle and showing the application roller placed over a rib of sheet metal material;

FIG. 7 is a front end view of the sealant tape apparatus of the present invention as shown in FIG. 6 showing an application roller that does not have flanges;

FIG. 8 is a front end view of the sealant tape apparatus of the present invention as shown in FIG. 6 showing an end of sealant tape extending from the sealant tape cradle over the application roller and down to a rib of sheet metal material; and

FIG. 9 is a flow chart that shows the steps of one advantageous embodiment of a method of the invention.

### DETAILED DESCRIPTION OF THE INVENTION

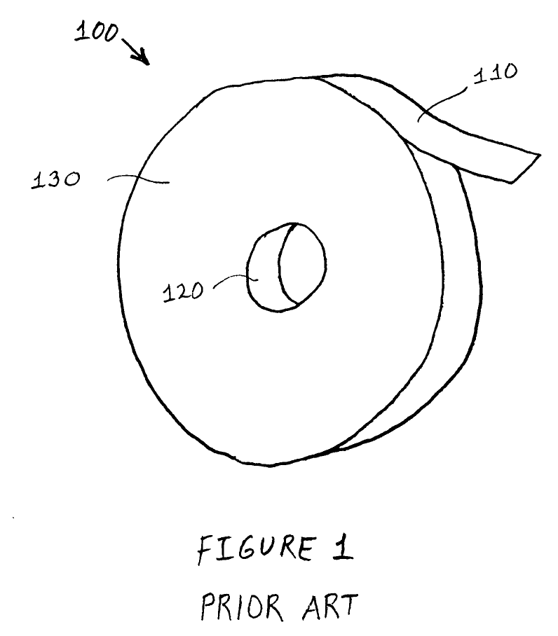

FIGS. 1 through 9, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged sealant tape apparatus.

FIG. 1 is perspective view of a prior art roll of sealant tape 100 of the type that is applied to a surface. The sealant tape comprises a length of tape 110 that is wound in a spiral manner around an axle (not shown in FIG. 1). When the axle is removed the sealant tape has the form of a disk having a hole 120 through the center of the disk. The side of the roll of sealant tape is designated with reference numeral 130. The side 130 of the roll is formed from the edges of the spirally wound tape 110.

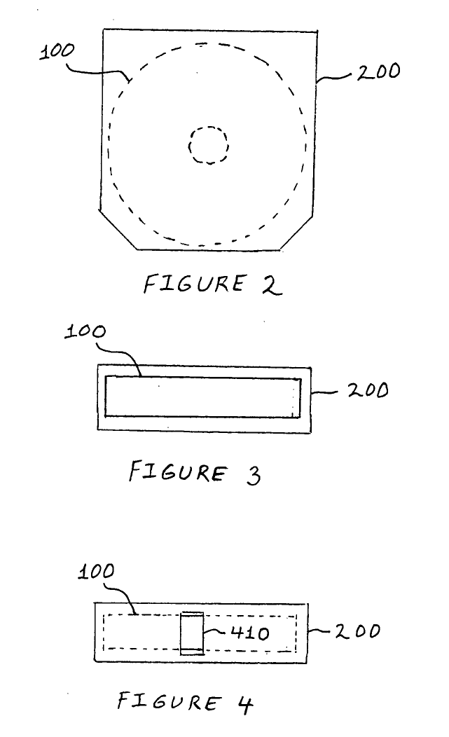

FIGS. 2, 3 and 4 illustrate a side view, a top view and a bottom view respectively of an advantageous embodiment of a sealant tape cradle 200 of the present invention. The sealant tape cradle 200 comprises a box structure that has interior dimensions that are capable of holding a roll of sealant tape 100 within the interior of the sealant tape cradle 200.

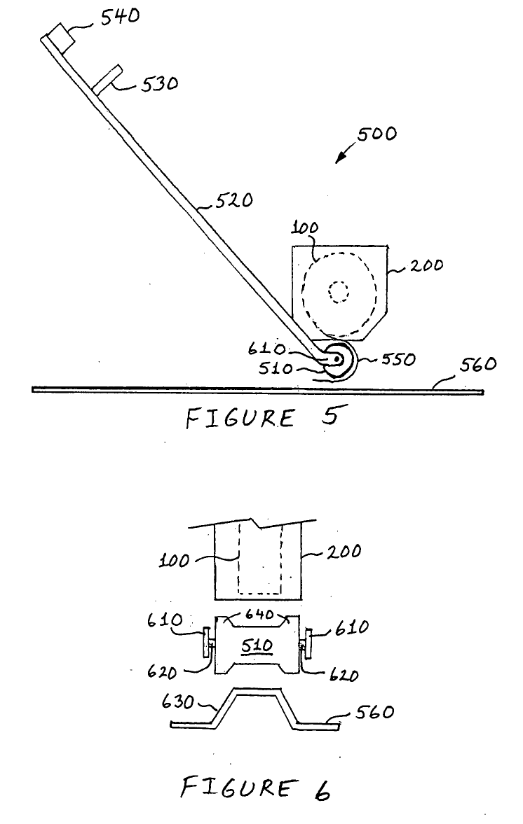

FIG. 2 is a side view of the sealant tape cradle 200. The location of a roll of sealant tape 100 is shown in dotted outline within the cradle. The roll of sealant tape 100 is aligned vertically and lowered into the interior of the sealant tape cradle 200. The bottom of the roll of sealant tape 100 is seated against the bottom of the sealant tape cradle 200. The person who is placing the roll of sealant tape 100 into the cradle 200 peels the outermost end of the tape away from the roll and threads the end of the tape through an aperture 410 (shown in FIG. 4) in the bottom of the cradle 200. As will be more fully described, the end of the sealant tape 100 will later be threaded around an application roller.

It is an important feature of the present invention that there is no axle (or other internal support structure) within the interior of the cradle 200 to support the roll of sealant tape 100. That is, the roll of sealant tape 100 is supported in its vertical position only by the bottom portion of the cradle 200 and the walls of the cradle 200. The sealant tape cradle 200 holds the roll of sealing tape 100 without using an internal support structure.

FIG. 3 is a top view of the sealant tape cradle 200 of the apparatus of the present invention. The top of the sealant tape cradle 200 is open to receive a roll of sealant tape 100 within the cradle 200. FIG. 3 shows the top of the roll of sealant tape 100 within the cradle 200 in solid outline.

FIG. 4 is a bottom view of the sealant tape cradle 200. The bottom of sealant tape cradle 200 has portions that form an aperture 410 through which an end of the sealant tape 100 may pass. The aperture 410 is shown in FIG. 4 as having a rectangular shape. The width of the aperture 410 is sufficient to allow the width of the end of the sealant tape 100 to pass freely through the aperture 410. The bottom of the roll of sealant tape 100 in cradle 200 is shown in dotted outline. The portion of the bottom of the roll of sealant tape that is visible through the aperture 410 is shown in solid outline.

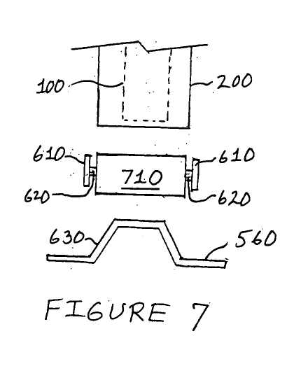

FIG. 5 is side view of the sealant tape apparatus 500 of the present invention comprising the sealant tape cradle 200, an application roller 510 and a support shaft 520. One side of the sealant tape cradle 200 is affixed to the support shaft 520 as shown in FIG. 5. The bottom end of support shaft 520 is formed having portions that define two oppositely located support flanges 610 that support two ends of an axle 620. Flanges 610 and axle 620 are shown in more detail in FIG. 6. Application roller 510 is rotatably mounted on axle 620.

As shown in FIG. 5, support shaft 520 of apparatus 500 comprises portions that form a hand grip 530 near the top end of support shaft 520. In one advantageous embodiment hand grip 530 is disposed perpendicularly to the length of the support shaft 520. Hand grip 530 allows an operator to grasp the support shaft 520 and operate the apparatus 500 with one hand.

Support shaft 520 also has portions that form a forearm brace 540 at the top end of the support shaft 520. The forearm brace 540 is located at a distance from the hand grip that is approximately equal to the length of a person's forearm. When an operator grasps the hand grip 530 the elbow of the operator will be located near the forearm brace 540. The forearm brace 540 stabilizes the support shaft 520 with respect to the forearm of the operator. The support that is provided by the forearm brace 540 allows an operator to efficiently guide the movement of the support shaft 520 and operate the apparatus 500.

In one advantageous embodiment of the invention the support shaft 520 is adjustable in length. An adjustable support shaft 520 comprises one or more mechanically telescoping portions that enable an operator to adjust the length of the support shaft 520. The length of the support shaft 520 may be adjusted to accommodate the height and arm length of the operator.

FIG. 5 also shows how the end of the sealant tape 100 that has been threaded through aperture 410 in the bottom of the cradle 200 passes around the application roller 510. The non-adhesive side of the sealant tape 100 (i.e., the “non-sticky” side) is adjacent to the outer surface of the application roller 510. This means that the sealant tape 100 will not stick to the surface of the application roller 510.

The apparatus and method of the invention is particularly effective for applying sealant tape 100 to a metal surface such as a metal sheet. It is understood, however, that the invention is not limited to use on a metal surface. The invention may be used to apply sealant tape 100 to any type of surface.

FIG. 5 illustrates how the apparatus 500 of the invention applies sealant tape 100 to a metal sheet 560. The adhesive side of the sealant tape 100 (i.e., the “sticky” side) is designated with reference numeral 550 in FIG. 5. As the operator pushes the support shaft 520 along the surface of the metal sheet 560, the application roller 510 presses the adhesive side 550 into contact with the metal sheet 560. The pressure applied by the application roller 510 is sufficient to seal the sealant tape 100 against the portions of the metal sheet 560 that are in contact with the sealant tape 100.

As the operator continues to push the support shaft 520 along the surface of the metal sheet 560, the applied pressure unrolls additional lengths of the sealant tape 100 from the roll of sealant tape that is located within sealant tape cradle 200. Gravity also aids in the unrolling of the roll of sealant tape 100.

Because there is no axle (or other internal support structure) within the interior of the cradle 200 to support the roll of sealant tape 100, the roll of sealant tape 100 is free to rotate within cradle 200 as the sealant tape 100 is dispensed. As the sealant tape 100 is dispensed, the size of the roll of sealant tape 100 decreases. As the size of the roll of sealant tape 100 decreases, the roll of sealant tape 100 drops further and further down toward the bottom of the cradle 200. Eventually, the roll of sealant tape 100 is completely dispensed and a new roll of sealant tape must be installed in the cradle 200.

FIG. 6 is a front end view of the sealant tape apparatus 500 of the present invention. FIG. 6 shows the position of the application roller 510 beneath the sealant tape cradle 200. FIG. 6 also shows the application roller 510 placed over a rib 630 of sheet metal 560. FIG. 6 also shows the roll of sealant tape 100 within cradle 200 in dotted outline.

In the advantageous embodiment of the apparatus 500 of the invention shown in FIG. 6, the application roller 510 is formed having portions that define flanges 640 on the outer edges of application roller 510. The flanges 640 guide the application of the sealant tape 100 as the sealant tape 100 is dispensed from the cradle 200.

In one advantageous embodiment of the invention a first application roller 510 may be removed from axle 620 and replaced with a second application roller 510 of a different size. The interchangeability of the application roller 510 enables the apparatus 500 to use sealant tapes 100 of different sizes (i.e., different widths).

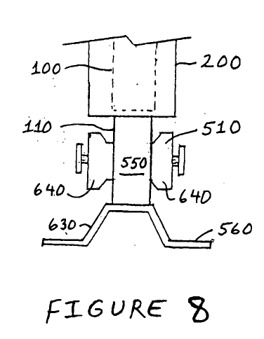

Some embodiments of the application roller 510 may not have flanges 640. FIG. 7 is a front end view of the sealant tape apparatus 500 of the present invention as shown in FIG. 6 showing an advantageous embodiment of the present invention that has an application roller 710 that does not have flanges.

The lack of an axle within the cradle 200 means that the cradle 200 is capable of holding and applying sealant tapes 100 having different sizes (i.e., different widths and different lengths). Because there is no axle within cradle 200, it is clear that cradle 200 is capable of holding both perfectly shaped rolls of sealant tape 100 and imperfectly shaped rolls of sealant tape 100.

FIG. 8 is a front end view of the sealant tape apparatus 500 of the present invention as shown in FIG. 6 showing an end 110 of sealant tape 100 extending from the sealant tape cradle 200 over the application roller 510 and down to the rib 630 of sheet metal 560. FIG. 8 illustrates how the pressure applied by the application roller 510 presses the adhesive side 550 of the end 110 of sealant tape 100 into contact with the rib 630 of metal sheet 560. The flanges 640 of the application roller 510 guide the application of the sealant tape 100 onto the rib 630. The flanges 640 can also facilitate the application of the sealant tape 100 onto a flat surface of metal sheet 560 (as shown in FIG. 5).

The present invention enables an operator to apply the sealant tape 100 to a metal surface using only one hand. First the end of the sealant tape 100 is threaded through the aperture 410 in the bottom of cradle 200 and threaded around the application roller 510. Then the operator places his or her arm in the forearm brace 540 and grasps the grip 530 of support shaft 520. Then the operator presses on the support shaft 520 to cause the application roller 510 to press the adhesive side 550 of the sealant tape 100 against the metal surface 560.

As the operator continues to press against the support shaft 520 (via hand grip 530) the application roller 510 moves along the metal surface 560 continually applying an unrolling length of sealant tape 100. In this manner the apparatus of the present invention enables the operator to apply sealant tape 100 to a metal surface 560 using only one hand. This means that the other hand of the operator is free to be used for some other task.

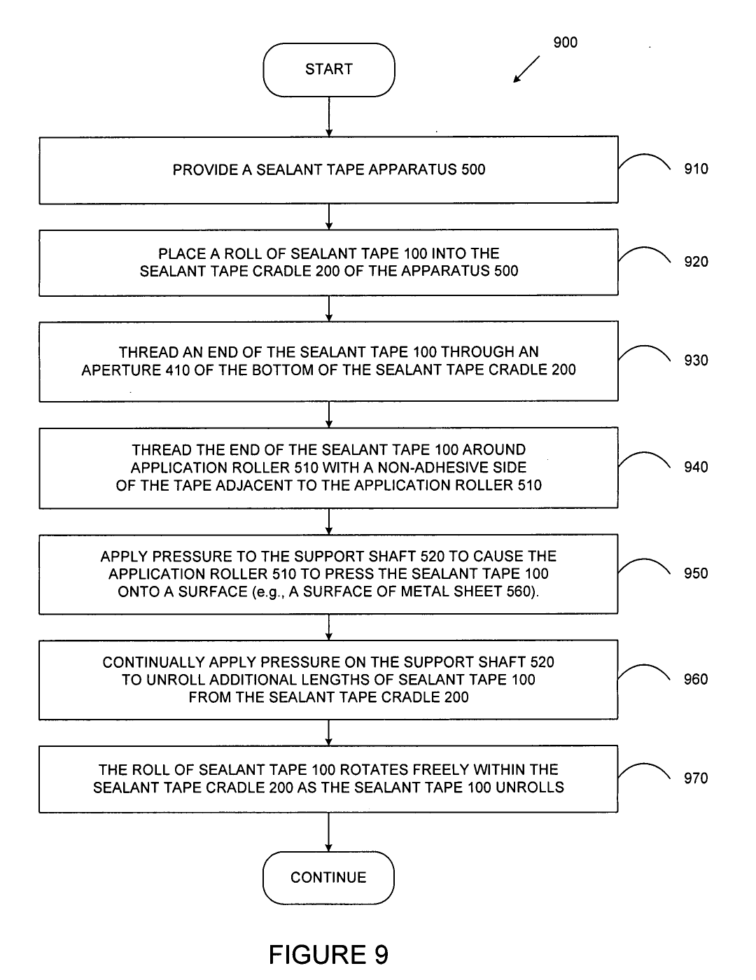

FIG. 9 is a flow chart 900 that shows the steps of one advantageous embodiment of a method of the invention. In the first step a sealant tape apparatus 500 of the invention is provided. (step 910). A roll of sealant tape 100 is then placed into the sealant tape cradle 200 of the apparatus 500. (step 920). Then the end of the sealant tape 100 is threaded through an aperture 410 in the bottom of the sealant tape cradle 200. (step 930).

Then the end of the sealant tape 100 is threaded around an application roller 510 with a non-adhesive side of the tape adjacent to the application roller 510 (step 940). Then pressure is applied to the support shaft 520 of the apparatus 500 to cause the application roller 510 to press the sealant tape 100 onto a surface (e.g., a surface of metal sheet 560). (step 950).

Then pressure is continually applied on the support shaft 520 to unroll additional lengths of sealant tape 100 from the sealant tape cradle. (step 960). The roll of sealant tape 100 rotates freely within the sealant tape cradle 200 as the sealant tape 100 unrolls. (step 970).

Although the present invention has been described in detail, those skilled in the art should understand that they can make various changes, substitutions and alterations herein without departing from the spirit and scope of the invention in its broadest form.

What is claimed is:

1. An apparatus for applying sealant tape to a surface wherein the apparatus comprises a sealant tape cradle that comprises portions that hold a roll of sealant tape without using an internal support structure.

2. The apparatus as set forth in claim 1 wherein the apparatus applies sealant tape to a metal surface.

3. The apparatus as set forth in claim 1 wherein the sealant tape cradle comprises walls and a bottom portion and holds a roll of sealant tape using only the walls and the bottom portion.

4. The apparatus as set forth in claim 3 wherein the bottom portion of the sealant tape cradle comprises portions that form an aperture that has a width that is sufficient to allow tape from the roll of sealant tape to pass through the aperture.

5. The apparatus as set forth in claim 1 further comprising:
a support shaft attached to the sealant tape cradle; and
an application roller attached to the support shaft that applies sealant tape from the sealant tape cradle to a surface.

6. The apparatus as set forth in claim 5 wherein the apparatus applies sealant tape to a metal surface.

7. The apparatus as set forth in claim 5 wherein the application roller is rotatably supported on the support shaft by an axle supported by two support flanges of the support shaft.

8. The apparatus as set forth in claim 5 wherein the application roller comprises flanges for guiding an application of tape from the sealant tape cradle to a surface.

9. The apparatus as set forth in claim 5 wherein the support shaft comprises a hand grip and a forearm brace.

10. The apparatus as set forth in claim 5 wherein a length of the support shaft is adjustable.

11. An apparatus for applying sealant tape to a surface wherein the apparatus comprises:
a support shaft;
a sealant tape cradle attached to the support shaft wherein the sealant tape cradle comprises portions that hold a roll of sealant tape without using an internal support structure; and
an application roller attached to the support shaft that applies sealant tape from the sealant tape cradle to a surface.

12. The apparatus as set forth in claim 11 wherein the apparatus applies sealant tape to a metal surface.

13. The apparatus as set forth in claim 11 wherein the application roller is rotatably supported on the support shaft by an axle supported by two support flanges of the support shaft.

14. The apparatus as set forth in claim 11 wherein the application roller comprises flanges for guiding an application of tape from the sealant tape cradle to a surface.

15. The apparatus as set forth in claim 11 wherein the support shaft comprises a hand grip and a forearm brace.

16. The apparatus as set forth in claim 11 wherein a length of the support shaft is adjustable.

17. A method for applying sealant tape to a surface, the method comprising the steps of:
providing an sealant tape apparatus that comprises a sealant tape cradle that is attached to a support shaft, wherein the sealant tape cradle comprises portions that hold a roll of sealant tape without using an internal support structure; and
placing a roll of sealant tape into the sealant tape cradle.

18. The method as set forth in claim 17 further comprising the steps of:
threading an end of the sealant tape through an aperture in a bottom of the sealant tape cradle; and
threading the end of the sealant tape around an application roller attached to the support shaft with a non-adhesive side of the sealant tape adjacent to the application roller.

19. The method as set forth in claim 18 further comprising the step of:
applying pressure to the support shaft of the sealant tape apparatus to cause the application roller to press the sealant tape onto a surface.

20. The method as set forth in claim 19 further comprising the steps of:
continually applying pressure to the support shaft of the sealant tape apparatus to cause the application roller to unroll additional lengths of sealant tape from the sealant tape cradle; and
allowing the roll of sealant tape within the sealant tape cradle to freely rotate as lengths of sealant tape are continually removed from the sealant tape cradle by the application roller.
